(19) United States
(12) Patent Application Publication
(10) Pub. No.: US 2018/0143466 A1
(43) Pub. Date: May 24, 2018

(54) LIGHT REACTION MACHINE

(71) Applicants: HKC Corporation Limited, Shenzhen City (CN); Chongqing HKC Optoelectronics Technology Co., ltd., Chongqing (CN)

(72) Inventor: CHUNG-KUANG CHIEN, Chongqing (CN)

(21) Appl. No.: 15/869,225

(22) Filed: Jan. 12, 2018

Related U.S. Application Data
(63) Continuation of application No. PCT/CN2017/094522, filed on Aug. 16, 2017.

(30) Foreign Application Priority Data
Nov. 23, 2016 (CN) 201611049124.4

(51) Int. Cl. G02F 1/13; G02B 19/00; B29C 35/08

(52) U.S. Cl. CPC G02F 1/1303; G02B 19/0019; B29L 2031/3475; G02F 2001/1316; B29C 35/0805

(57) ABSTRACT

The present application provides a light reaction machine including: a box including a bottom, a top, and a lateral wall between the bottom and the top; a temperature and humidity controller on the bottom, controlling temperature, humidity, and oxygen content inside the box; a transparent substrate on the temperature and humidity controller, including a first face and a second face opposite to the first face; a first light source on the top, irradiating the first face; a second light source between the transparent substrate and the temperature and humidity controller, irradiating the second face; a transparent carrier between the transparent substrate and the second light source, loading the transparent substrate; and a reflector on the lateral wall, reflecting light emitting to the lateral wall to the transparent substrate.

### FIELD OF THE DISCLOSURE

The present disclosure relates to light application field, and more particularly, to a light reaction machine.

### BACKGROUND

With continuous development of technique, each kind of electronic product are produced endlessly. Light plays an important role in the manufacturing process of the elements of the electronic devices, especially in the liquid crystal display field. Light can perform a treatment such as sealing of the liquid crystal transparent plate, curing of the sealing glue, cleaning of surface organic materials, surface property change of the coating layer, and so on.

In the conventional art, however, light usually irradiates one surface of a transparent substrate in the treatment such as sealing of the liquid crystal plate, curing of the sealing glue, cleaning of surface organic materials, surface property change of the coating layer, and so on. The reacting materials of the surface of the transparent substrate cannot react thoroughly so it cannot achieve prospective reacting effect.

### SUMMARY

An embodiment of the present application provides a light reaction machine irradiating two faces of the transparent substrate simultaneously so the reacting materials on the surfaces of the transparent substrate can react thoroughly. It can be applied to treatments such as sealing of the liquid crystal plate, curing of the sealing glue, cleaning of surface organic materials, surface property change of the coating layer, and so on. This light reaction machine has multiple functions.

An embodiment of the present application provides a light reaction machine including: a box including a bottom, a top, and a lateral wall located between the bottom and the top; a first light source disposed on the top, used for irradiating a first face of a transparent substrate, wherein the transparent substrate includes the first face and a second face opposite to the first face; a temperature and humidity controller disposed on the bottom, used for controlling temperature, humidity, and oxygen content inside the box; a second light source disposed on the temperature and humidity controller, used for irradiating the second face of the transparent substrate; a transparent carrier disposed on the second light source, used for loading the transparent substrate; and a reflector disposed on the lateral wall, reflecting irradiated onto the lateral wall of the box to the transparent substrate.

In an embodiment, the first light source and the second light source are array light sources, and the array light sources include a plurality of lamps regularly arranged.

In an embodiment, the lamp is a point light source, a line light source, or a surface light source.

In an embodiment, the plurality of lamps regularly arranged are arranged to form a rectangular array, a circular array, or a regular polygon array.

In an embodiment, the first light source and the second light source are ultraviolet light sources, visible light sources, or infrared light sources.

In an embodiment, the transparent carrier comprises a transparent material penetrated by light.

In an embodiment, the transparent carrier is a grating structure having a plurality of slits with the same intervals.

In an embodiment, the transparent carrier includes a plurality of discrete structures distributed with the same intervals.

In an embodiment, the first light source and the second light source are array light sources, and the array light sources include a plurality of lamps regularly arranged.

The transparent carrier is a grating structure having a plurality of slits with the same intervals.

Each slit of the transparent carrier is disposed facing the lamps of one line or one row of the second light source.

In an embodiment, the first light source and the second light source are array light sources, and the array light sources include a plurality of lamps regularly arranged.

The transparent carrier includes a plurality of discrete structures distributed with the same intervals.

The interval between every two discrete structures is disposed facing the lamps of one line or one row of the second light sources.

In an embodiment, the first light source includes a back plate to form a top cap of the box.

In an embodiment, the box includes four lateral walls including the reflectors thereon.

In an embodiment, the reflector is a scattering reflector.

In an embodiment, the transparent substrate is a glass substrate or a flexible transparent substrate.

In an embodiment, the light reaction machine further includes a light control module connected with the first light source and the second light source respectively, used for adjusting intensity of the light emitted from different areas of the first light source and the second light source, and controlling on/off of the first light source and the second light source.

In an embodiment, the light control module controls the first light source and the second light source to enhance the light intensity right on a seal and a frame of the transparent substrate.

In an embodiment, the light control module is a light dimmer.

In an embodiment, the light reaction machine further includes a temperature and humidity sensor disposed in the box and connected with the temperature and humidity controller, used for detecting temperature data and humidity data inside the box and feedbacking the temperature data and the humidity data to the temperature and humidity controller.

An embodiment of the present application provides a light reaction machine including: a box including a bottom, a top, and a lateral wall located between the bottom and the top; a first light source disposed on the top, used for irradiating a first face of a transparent substrate, wherein the transparent substrate includes the first face and a second face opposite to the first face; a temperature and humidity controller disposed on the bottom, used for controlling temperature, humidity, and oxygen content inside the box; a temperature and humidity sensor disposed in the box and connected with the temperature and humidity controller, used for detecting temperature data and humidity data inside the box and feedbacking the temperature data and the humidity data to the temperature and humidity controller; a second light source disposed on the temperature and humidity controller, used for irradiating the second face of the transparent substrate; a light control module connected with the first light source and the second light source respectively, used for adjusting intensity of the light emitted from different areas of the first light source and the second light source, and controlling on/off of the first light source and the second light source; a transparent carrier disposed on the second light source, used for loading the transparent substrate; a reflector disposed on the lateral wall, used for reflecting irradiated onto the lateral wall of the box to the transparent substrate; and a control module disposed outside the box, connected with the first light source, the second light source, the temperature and humidity controller, the temperature and humidity sensor, and the light control module respectively and used for controlling working status of the first light source, the second light source, the temperature and humidity controller, the temperature and humidity sensor, and the light control module respectively.

In an embodiment, the control module is a personal computer client.

An embodiment of the present application provides a light reaction machine having two light sources irradiating the first face and the second face of the transparent substrate respectively so the reacting materials on the surfaces of the transparent substrate can react thoroughly. It can be applied to the treatments such as sealing of the liquid crystal plate, curing of the sealing glue, cleaning of surface organic materials, surface property change of the coating layer, and so on. This light reaction machine has multiple functions.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structure schematic view of a light reaction machine in accordance with an embodiment of the present application.

FIG. 2 is a structure schematic view of an array light source in accordance with an embodiment of the present application.

FIG. 3 is a structure schematic view of a transparent carrier in accordance with an embodiment of the present application.

FIG. 4 is a structure schematic view of a light reaction machine in accordance with an embodiment of the present application.

FIG. 5 is a schematic diagram of a light reaction machine in accordance with an embodiment of the present application.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

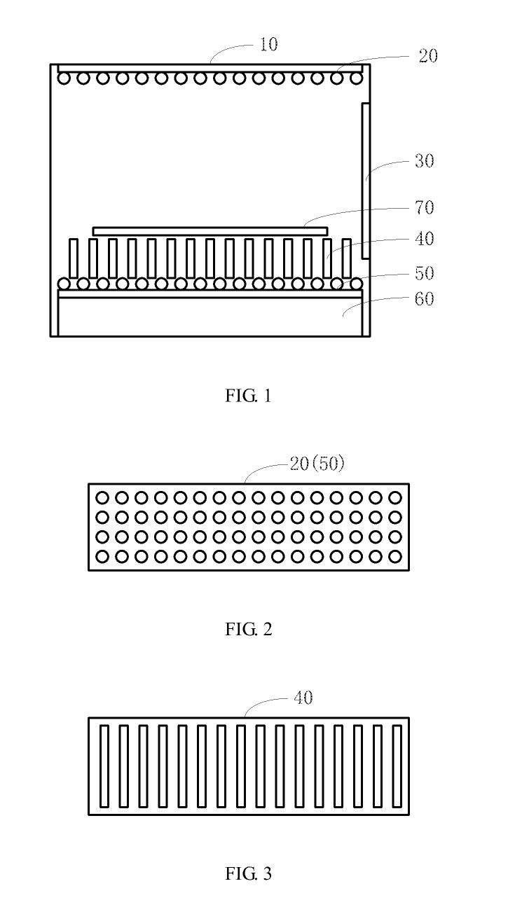

Referring FIG. 1, a light reaction machine in accordance with an embodiment of the present application includes a box 10, a first light source 20, a reflector 30, a transparent carrier 40, a second light source 50, and a temperature and humidity controller 60.

The first light source 20 is disposed on a top inside the box 10. The temperature and humidity controller 60 is disposed on a bottom inside the box 10. The second light source 50 is disposed on the temperature and humidity controller 60. The transparent carrier 40 is disposed on the second light source 50. The reflector 30 is disposed on a lateral inner wall of the box 10.

The transparent carrier 40 is used for loading a transparent substrate 70. In some embodiments, the transparent substrate 70 can be transported into the box 10 by mechanical transportation devices such as mechanical arms or rollers.

In a particular application, the transparent substrate 70 can be a glass substrate or a flexible transparent substrate.

In a particular application, the transparent carrier 40 can be made of transparent materials penetrated by light such as glass or acrylic.

Referring FIGS. 1 and 3, in an embodiment of the present application, the transparent carrier 40 is composed of a plurality of discrete structures distributed with the same intervals.

The first light source 20 is used for irradiating a first face of the transparent substrate 70.

The second light source 50 is used for irradiating a second face of the transparent substrate 70.

In a particular application, the first light source 20 and the second light source 50 can be ultraviolet light sources or other wavelength light sources such as visible light sources or infrared light sources.

In a particular application, the first face and the second face of the transparent substrate 70 are two surfaces having biggest area and disposed opposite to each other.

Referring FIG. 1, in an embodiment of the present application, the first light source 20 and the second light source 50 are array light sources. The array light sources are composed of a plurality of lamps arranged regularly.

In a particular application, the lamp can be a point light source, a line light source, or a surface light source. The lamps can be arranged to be an array with any shapes such as a rectangular array, a circular array, or a regular polygon array. The light from the array light source has to ensure thoroughly covering the surface of the transparent substrate 70.

The reflector 30 is used for reflecting light irradiating the lateral walls of the box 10 to the transparent substrate 70.

The temperature and humidity controller 60 is used for controlling the temperature, humidity, and oxygen content inside the box 10.

The embodiment of the present application is to set two light sources in the box of the light reaction machine. The two light sources are used for irradiating the first face and the second face of the transparent substrate respectively so the reacting materials on the surfaces of the transparent substrate can react thoroughly. It can be applied to the treatments such as sealing of the liquid crystal plate, curing of the sealing glue, cleaning of surface organic materials, surface property change of the coating layer, and so on. This light reaction machine has multiple functions.

Referring FIG. 2, in an embodiment of the present application, the array light source includes a plurality of point light sources arranged as rectangular array. In other embodiments, the array light source can include a line light source or a surface light source arranged as other shapes. The embodiment of the present application arrange the array light source as different shape arrays so it can be applicable to the transparent substrates having different shapes.

In an embodiment of the present application, the light reaction machine further includes a light control module connected with the first light source and the second light source. The light control module is used for adjusting intensity of the light emitted from different areas of the first light source and the second light source and control on/off of the first light source and the second light source.

In an embodiment of the present application, the light control module is used for controlling the first light source and the second light source to enhance the light intensity right on the seal and the frame of the transparent substrate.

In a particular application, the light control module can be a light dimmer.

In a particular application, the light reaction machine can increase light intensity or amount of the lamps emitting light right to the seal and the frame of the transparent substrate when the light reaction machine is applied to the sealing of the transparent substrate and curing of the sealing glue, for thoroughly reaction of the reacting materials on the seal and the frame of the transparent substrate. At the same time, it can decrease light intensity or amount of the lamps emitting light to the positions other than the seal and the frame of the transparent substrate for avoiding wasting resource. Similarly, it can change light intensity or amount of the light source according to practical requirement to enhance intensity of the light irradiating stain positions of the transparent substrate where it needs to be clean, when the light reaction machine is applied to cleaning the transparent substrate. It can be applied to other situations which need to enhance intensity of the light irradiating partial positions of the transparent substrate. It is not iterated.

Referring FIG. 3, in an embodiment of the present application, the transparent carrier 40 is a grating structure having a plurality of slits with the same intervals.

In an embodiment of the present application, the second light source 50 is an array light source. The array light sources are composed of a plurality of lamps arranged regularly.

The transparent carrier 40 is the grating structure having the plurality of slits with the same intervals.

Each slit of the transparent carrier 40 is disposed facing the lamps of one line or one row of the second light source 50.

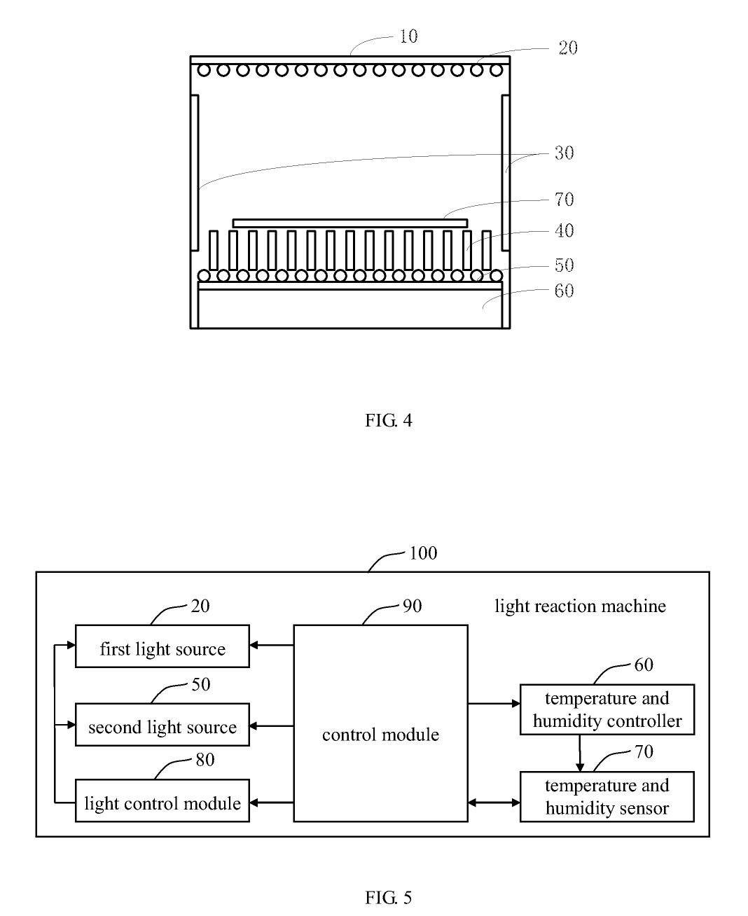

Referring FIG. 1 or FIG. 4, in an embodiment of the present application, the second light source 50 is an array light source. The array light sources are composed of a plurality of lamps arranged regularly.

The transparent carrier 40 is composed of a plurality of discrete structures distributed with the same intervals.

The interval between every two discrete structures is disposed facing the lamps of one line or one row of the second light source 50.

In this embodiment, the lamps of one line or one row of the second light source are disposed facing the slits or the intervals of the transparent carrier so it can ensure that the light from the second light source can irradiate the second face of the transparent substrate through the transparent carrier.

Referring FIG. 4, in an embodiment of the present application, a back plate of the first light source 20 forms a top cap of the box 10. The reflectors 30 are disposed on four lateral walls of the box 10 (only two reflectors on the right and the left lateral walls are shown). In this embodiment, the back plate of the first light source 20 is adopted as the top cap of the box 10 so the structure of the light reaction machine can be simplified and save the manufacturing cost. It is convenient to change the first light sources when the first light sources are damaged as well. Disposing the reflectors on the four lateral walls can reflect the light scattering to the lateral walls of the box to the transparent substrate at the most.

In a particular application, the reflector can be particularly a scattering reflector so the light scattering to the lateral walls of the box can be reflected to the transparent substrate at the most. The light can totally cover the areas of light reaction on the transparent substrate.

In an embodiment of the present application, the light reaction machine further includes a control module disposed outside the box and connected with the first light sources, the second light sources, and the temperature and humidity controller respectively. The control module is used for controlling the working status of the first light sources, the second light sources, and the temperature and humidity controller respectively.

In a particular application, the control module can be particularly a personal computer client. It also can be integrated circuit such as Central Processing Unit (CPU) or Application Specific Integrated Circuit (ASIC).

In an embodiment of the present application, the control module is connected with the light control module to control the working status of the first light sources and the second light sources via the light control module.

In an embodiment of the present application, the light control module can particularly be a software module of the control module.

In an embodiment of the present application, the light reaction machine further includes a temperature and humidity sensor disposed in the box and connected with the temperature and humidity controller. The temperature and humidity sensor is to detect temperature data and humidity data inside the box, and feedback the temperature data and the humidity data to the temperature and humidity controller. It can detect temperature and the humidity inside the box of the light reaction machine to keep temperature and humidity in normal range and benefit the light reaction.

Similarly, the control module can control the temperature and humidity controller to adjust the temperature and humidity inside the box to a predetermined range when it monitors the temperature and the humidity inside the box according to temperature data and humidity data and finds the temperature and the humidity outside the predetermined range. In a particular application, the predetermined range can be disposed according to the practical requirement. The predetermined range includes a temperature maximum, a temperature minimum, a humidity maximum, and a humidity minimum.

In an embodiment of the present application, the control module can conduct integrated control to the working status of each element in the light reaction machine to coordinate the working status of the light reaction machine. The light reaction machine can effectively promote light reaction of the chemical materials on the surface of the transparent glass substrate to improve speed and quality of light reaction.

Referring FIG. 5, a light reaction machine 100 in accordance with an embodiment of the present application includes the box 10 (not shown), the first light source 20, the reflector 30 (not shown), the transparent carrier 40 (not shown), the second light source 50, the temperature and humidity controller 60, the temperature and humidity sensor 70, the light control module 80, and the control module 90. The temperature and humidity sensor 70 is connected with the temperature and humidity controller 60, the light control module 80 is connected with the first light source 20 and the second light source 50 respectively, and the control module 90 is connected with the first light source 20, the second light source 50, the temperature and humidity controller 60, the temperature and humidity sensor 70, and the light control module 80 respectively so it can control the working status of the first light source 20, the second light source 50, the temperature and humidity controller 60, the temperature and humidity sensor 70, and the light control module 80 respectively.

FIG. 5 merely shows the electrical connection among the elements for instance, not the mechanical structures and relative positions.

It is noted that it expands dimension of the layer and the region for clear in the figures. It is understood that each layer is not limited in one element and can include multiple elements. In addition, it is understood that when the element or the layer is on “one side” of another element or another layer, it can be on other elements directly or exist at the middle layer.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A light reaction machine comprising:
a box;
a first light source, disposed on a top section in the box, used for irradiating a first face of a transparent substrate;
a temperature and humidity controller disposed on a bottom section in the box, used for controlling temperature, humidity, and oxygen content in the box;
a second light source, disposed on the temperature and humidity controller, used for irradiating a second face of the transparent substrate;
a transparent carrier, disposed on the second light source, used for supporting the transparent substrate; and
a reflector disposed on a lateral wall in the box, used for reflecting light irradiated onto the lateral wall of the box to the transparent substrate.

2. The light reaction machine according to claim 1, wherein the first light source and the second light source are array light sources, and the array light sources comprise a plurality of lamps regularly arranged.

3. The light reaction machine according to claim 2, wherein the lamp is a point light source, a line light source, or a surface light source.

4. The light reaction machine according to claim 2, wherein the plurality of lamps regularly arranged are arranged to form a rectangular array, a circular array, or a regular polygon array.

5. The light reaction machine according to claim 2, wherein the first light source and the second light source are ultraviolet light sources, visible light sources, or infrared light sources.

6. The light reaction machine according to claim 1, wherein the transparent carrier comprises a transparent material penetrated by light.

7. The light reaction machine according to claim 1, wherein the transparent carrier is a grating structure having a plurality of slits with the same intervals.

8. The light reaction machine according to claim 1, wherein the transparent carrier comprises a plurality of discrete structures distributed with the same intervals.

9. The light reaction machine according to claim 1, wherein the first light source and the second light source are array light sources, and the array light sources comprise a plurality of lamps regularly arranged;
wherein the transparent carrier is a grating structure having a plurality of slits with the same intervals;
wherein each slit of the transparent carrier is disposed facing the lamps of one line or one row of the second light source.

10. The light reaction machine according to claim 1, wherein the first light source and the second light source are array light sources, and the array light sources comprise a plurality of lamps regularly arranged;
wherein the transparent carrier comprises a plurality of discrete structures distributed with the same intervals;
wherein the interval between every two discrete structures is disposed facing the lamps of one line or one row of the second light source.

11. The light reaction machine according to claim 1, wherein the first light source comprises a back plate to form a top cap of the box.

12. The light reaction machine according to claim 1, wherein the box comprises four lateral walls comprising the reflectors thereon.

13. The light reaction machine according to claim 1, wherein the reflector is a scattering reflector.

14. The light reaction machine according to claim 1, wherein the transparent substrate is a glass substrate or a flexible transparent substrate.

15. The light reaction machine according to claim 1, further comprising a light control module connected with the first light source and the second light source respectively, used for adjusting intensity of the light emitted from different areas of the first light source and the second light source, and controlling on/off of the first light source and the second light source.

16. The light reaction machine according to claim 15, wherein the light control module controls the first light source and the second light source to enhance the light intensity right on a seal and a frame of the transparent substrate.

17. The light reaction machine according to claim 15, wherein the light control module is a light dimmer.

18. The light reaction machine according to claim 1, further comprising a temperature and humidity sensor disposed in the box and connected with the temperature and humidity controller, used for detecting temperature data and humidity data inside the box and feedbacking the temperature data and the humidity data to the temperature and humidity controller.

19. A light reaction machine comprising:
a box;
a first light source, disposed on a top section in the box, used for irradiating a first face of a transparent substrate;
a temperature and humidity controller, disposed on a bottom section in the box, used for controlling temperature, humidity, and oxygen content in the box;
a temperature and humidity sensor, disposed in the box and connected with the temperature and humidity controller, used for detecting temperature data and humidity data in the box and feedbacking the temperature data and the humidity data to the temperature and humidity controller;
a second light source, disposed on the temperature and humidity controller, used for irradiating a second face of the transparent substrate;
a light control module, connected with the first light source and the second light source respectively, used for adjusting intensity of the light emitted from different areas of the first light source and the second light source, and controlling on/off of the first light source and the second light source;
a transparent carrier disposed on the second light source, used for loading the transparent substrate;
a reflector disposed on the lateral wall, used for reflecting irradiated onto the lateral wall of the box to the transparent substrate; and
a control module, disposed outside the box, connected with the first light source, the second light source, the temperature and humidity controller, the temperature and humidity sensor, and the light control module respectively and used for controlling working status of the first light source, the second light source, the temperature and humidity controller, the temperature and humidity sensor, and the light control module respectively.

20. The light reaction machine according to claim 19, wherein the control module is a personal computer client.
